(19) United States
(12) Patent Application Publication
(10) Pub. No.: US 2001/0050787 A1
(43) Pub. Date: Dec. 13, 2001

(54) Electro-optical component having a reconfigurable phase state

(75) Inventors: William Alden Crossland, Essex (GB); Timothy David Wilkinson, Cambridge (GB); Kamran Eshraghian, Mindarie (AU)

Correspondence Address: Charles N.J. Ruggiero, Esq., Ohlandt, Greeley, Ruggiero & Perle, L.L.P., One Landmark Square, 10th Floor, Stamford, CT, 06901-2682, US

(73) Assignee: Intelligent Pixels, Inc.

(21) Appl. No.: 09/860,289

(22) Filed: May 18, 2001

Related U.S. Application Data
(60) Provisional application No. 60/206,074, filed on May 22, 2000.

(51) Int. Cl. G03H 1/02; G03H 1/08; G02B 5/32; H04J 14/02

(52) U.S. Cl. 359/15; 359/3; 359/9; 359/128

(57) ABSTRACT

There is provided an electro-optical component comprising (a) a substrate, (b) a phase-variable element carried on the substrate, (c) a memory carried on the substrate for storing data representative of a phase state for the phase-variable element; and (d) a controller carried on the substrate, for utilizing the data and setting the phase state for the element. There is also provided an electro-optical component comprising (a) a substrate, (b) a phase-variable element carried on the substrate, and (c) a circuit carried on the substrate for computing and applying a phase state for the phase-variable element.

### CROSS REFERENCE TO RELATED APPLICATIONS

The present application is claiming priority of U.S. Provisional Patent Application Serial No. 60/206,074 filed on May 22, 2000.

### BACKGROUND OF THE INVENTION 1. Field of the Invention

The present invention relates to an electro-optical component having a reconfigurable phase state. The component is particularly suitable for steering an optical beam. Such a component can be used in applications such as metropolitan area network (MAN) optical terabit switching/routing, all-optical cross-connect systems for dense wave division multiplexing (DWDM) networks, photonics signal processing, and free space laser communication.

2. Description of the Prior Art

One of the most critical elements within the framework of optical transport networks based on wavelength-division multiplexing is an optical cross-connect (OXC). This optical routing device provides network management in the optical layer, with potential throughputs of terabits per second. An optical cross connection may be accomplished by either a hybrid approach or by an all-optical approach.

The hybrid approach converts an optical data stream into an electronic data stream. It uses an electronic cross connection, and then performs an electrical-optical conversion. There is an inherent problem with the hybrid approach when used in a networked environment. Historically, microprocessor speed has doubled almost every 18 months, but demand for network capacity has increased at a much faster rate, thus causing a widening gap between the microprocessor speed and the volume of network traffic. The effect of this gap places a great burden on the electronic cross connections for optical links that are implemented in metropolitan and long-haul networks. Optical carrier 48 (OC-48) is one of the layers of hierarchy in a conventional synchronous optical network (SONET). The procedure of optical-electrical-optical (OEO) conversion becomes more difficult as the speed of the link reaches OC-48 (2.5 Gbps), and is even more difficult at higher speeds. At such speeds, the electronic circuitry of the OEO causes a network bottleneck.

The all optical approach performs the cross connection entirely in the optical domain. The all optical approach does not have the same speed limitations as the hybrid approach. It is normally used for fiber channel, high bandwidth cross connections. Taking N×N to represent the dimension of the OXC, i.e. the number of input and output ports, then N is typically between 2 and 32 for an all optical OXC. However, larger dimension OXCs, with N up to several hundreds or even a thousand are contemplated. Many proposed optical cross-connect architectures include a set of optical space switches capable of switching a large number of input and output fibers. However, despite a significant investment for development of an all photonics OXC, it is presently a major challenge to design a reliable all photonics, non-blocking, low loss, scalable and reconfigurable optical switch, even for N in the order of 32-40.

Several different technologies have been tried for optical interconnects, but none is yet regarded as a technology or market place leader. This is due, in part, to an impracticality of the switching media or to a lack of scalability in cross-connecting a suitable number of input and output ports.

For example, guided wave systems use nonlinear electro-optic components, sometimes with diffraction effects, to couple optical signals from one fiber wave-guide to another. Prominent attention in this class of devices has been given to fiber Bragg switches and other fiber proximity coupling schemes such as devices using electro-optic effects in lithium niobite, silica or polymer based materials. A limitation of these switch mechanisms is scalability. It is difficult to construct guided wave switches greater than an 8×8 size because they use substrates of limited size. The interconnection of several small switches to construct a large switch is also impractical because of the bulkiness of optical fiber harnesses.

An advantage of a free-space optical switching system is that it can exploit the non-interference property of optical signals to switch a large number of optical ports. The two most common mechanisms for beam steering in this class of devices are diffraction and mechanical steering.

For mechanical beam steering devices, a good deal of development effort appears to be concentrated on mirrors using micro electro mechanical systems (MEMS). Several devices being manufactured commercially, such as the Lambda Router™ from Lucent Technologies, Inc.

Another mechanical approach that has received considerable attention is the use of micro-“bubbles”, such as in the N3565A “32×32 Photonic Switch”, offered by Agilent Technologies. In a micro-bubble system, the index of refraction of a transmission media is modified by mechanically moving a microscopic bubble in the media.

Disadvantages of a MEMS-based switch include limitations relating to mechanical, thermal and electrostatic stability. A MEMS-based switch typically requires continuous adaptive alignment to maintain a connection and its reliability is a function of that adaptive alignment. Another disadvantage of the MEMS-based switch is its optics, which typically require highly collimated optical paths, usually employing microlenses that cannot significantly diffract the light beam.

In diffractive steering, an optical signal is redirected using a phase hologram, also known as a grating or a diffraction pattern, recorded on a spatial light modulator. Several materials have been proposed for use in such systems, including III-V semiconductors such as InGaAs/InP, and liquid crystal on silicon systems (LCOS). One advantage of using direct-gap semiconductors is the ease with which active optical components, such as lasers and optical amplifiers, can be incorporated into a circuit, thus allowing the possibility of signal boosting at the switching stage. A disadvantage of such materials is the cost and difficulty of large-scale manufacturing.

### SUMMARY OF THE INVENTION

It is an object of the present invention to provide an improved optical component having a variable phase state.

It is another object of the present invention to employ such a component in an optical switch in which a plurality of the components are configured in an array for phase modulating light in order to steer the light from an input port to an output port by diffraction.

It is yet another object of the present invention to provide such a switch in which the array of phase modulating components and the parallel processing capability are both carried on the same substrate.

It is a further object of the present invention to provide such a switch in which the circuit computes a reconfigurable phase pattern or hologram to optimize the performance of the switch by reducing optical losses, and to minimize the quanta of optical signal falling into adjacent channels, i.e. crosstalk.

It is yet a further object of the present invention to provide such a switch in which a hologram routes light from a single input port to a single output port, or from a single input port to multiple output ports, i.e., multicasting, or from multiple input ports to a single output port, i.e., inverse-multicasting.

These and other objects of the present invention are provided by an electro-optical component in accordance with the present invention. One embodiment provides an electro-optical component comprising (a) a substrate, (b) a phase-variable element carried on the substrate, (c) a memory carried on the substrate for storing data representative of a phase state for the phase-variable element; and (d) a controller carried on the substrate, for utilizing the data and setting the phase state for the element. Another embodiment provides an electro-optical component comprising (a) a substrate, (b) a phase-variable element carried on the substrate, and (c) a circuit carried on the substrate for computing a phase state for the phase-variable element.

### BRIEF DESCRIPTION OF THE DRAWINGS

FIG. 1 is a schematic representation of an optical switch in accordance with the present invention.

FIGS. 2A and 2B are schematic representations of alternate embodiments of optical switches in accordance with the present invention.

FIG. 3 is an illustration showing a relationship between a hologram and its replay field.

FIG. 4 is a side-section view of a spatial light modulator, as used in an optical switch in accordance with the present invention.

FIGS. 5A-5C are illustrations of various arrangements of one or more phase-variable elements and circuitry on a substrate.

FIG. 6 is a flowchart of an algorithm for generating a hologram by projection of constraints.

FIG. 7 is a schematic representation of an optical switch in accordance with the present invention.

### DESCRIPTION OF THE INVENTION

An embodiment of the present invention provides for an electro-optical component comprising (a) a substrate, (b) a phase-variable element carried on the substrate, (c) a memory carried on the substrate for storing data representative of a phase state for the phase-variable element; and (d) a controller carried on the substrate, for utilizing the data and setting the phase state for the phase-variable element. The component can be employed in an optical switch to direct light from a first port to a second port.

Another embodiment of the present invention provides for an electro-optical component comprising (a) a substrate, (b) a phase-variable element carried on the substrate, and (c) a circuit carried on the substrate for computing a phase state for the phase-variable element. This component can also be employed in an optical switch to direct light from a first port to a second port.

In another embodiment, the optical switch includes (a) a substrate, (b) a liquid crystal carried on the substrate; and (c) a circuit carried on the substrate for computing a hologram and controlling the liquid crystal to produce the hologram to direct light from a first port to a second port.

The optical switch uses a dynamic beam steering phase hologram written onto a liquid crystal over silicon (LCOS) spatial light modulator (SLM). A phase hologram is a transmissive or reflective element that changes the phase of light transmitted through, or reflected by, the element. A replay field is the result of the phase hologram. The LCOS SLM produces a hologram, i.e., a pattern of phases, that steers light by diffraction in order to route the light from one or more input fibers to one or more output fibers.

The holograms produced on the SLM may appear as a one-dimensional or two-dimensional image. Accordingly, the image elements, whether transmissive or reflective, are sometimes referred to as “pixels”, i.e., picture elements.

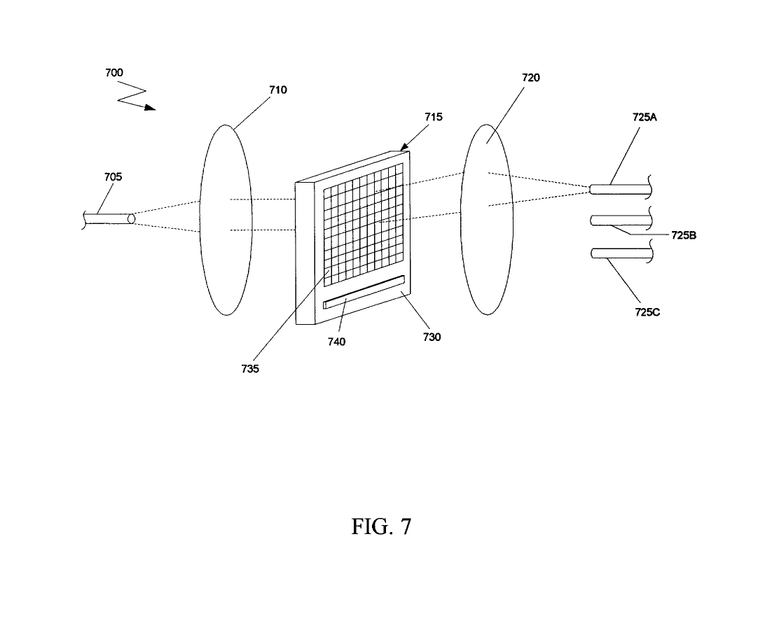

FIG. 7 is a schematic representation of an optical switch 700 in accordance with the present invention. The principal elements of switch 700 include an input port 705, a spatial light modulator (SLM) 715, and a plurality of output ports 725A, 725B and 725C. A first lens 710 is interposed between input port 705 and SLM 715, and a second lens 720 is interposed between SLM 715 and output ports 725A, 725B and 725C.

Light from input port 705 is cast upon lens 710, which collimates the light and projects it onto SLM 715. The light travels through SLM 715 and onto lens 720, which focuses the light onto one or more of output ports 725A, 725B and 725C. A hologram produced on SLM 715 directs the light to one or more of output ports 725A, 725B and 725C. In FIG. 7, the light is shown as being directed to output port 725A.

SLM 715 is an electro-optical component that includes a substrate 730 upon which is carried (a) an element, shown in FIG. 7 as one of an array of elements 735 and (b) a circuit 740. Elements 735 have a variable phase. That is, the phase, i.e., time delay, of light propagating through elements 735 can be varied. When the phase of light propagating through an element 735 is varied relative to the phase of another element 735, the light forms an interference pattern that influences the direction in which the light travels, as is well known in the field of optics. Thus, by controlling the relative phasing, the light can be directed to a desired target. Liquid crystal is a suitable material for elements 735. Liquid crystal is conventionally provided in a thin film sheet, and as such, individuals of elements 735 would correspond to regions of the liquid crystal rather than being discrete, separate, liquid crystal elements.

Circuit 740 sets the phase states for elements 735 for directing the light from input port 705 to output port 725A. That is, a hologram is produced by elements 735. Optionally, circuit 740 also computes the hologram. In FIG. 7, the result of the hologram causes a point of light intensity at output port 725A.

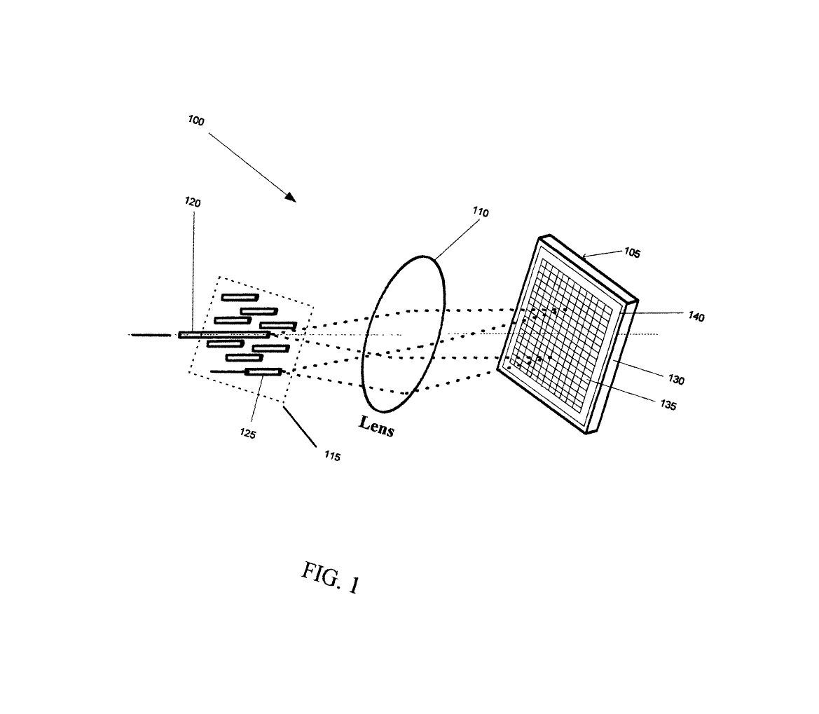

FIG. 1 is a schematic representation of an optical switch 100 in accordance with the present invention. The principal components of switch 100 include a fiber array 115, an SLM 105, and a lens 110 interposed between fiber array 115 and SLM 105.

Fiber array 115 has a first port 120 and a second port 125. Light enters switch 100 via first port 120 and proceeds to lens 110, which is, for example, a Fourier lens having a positive focal length. Lens 110 collimates the light. From lens 110, the light is projected onto SLM 105. The light is reflected by SLM 105, and travels via lens 110 to second port 125. As explained below, a hologram produced on SLM 105 steers the light from first port 120 to second port 125.

SLM 105 is an electro-optical component that includes a substrate 130 upon which is disposed (a) a reflective element, shown in FIG. 1 as one of an array of reflective elements 135, and (b) a circuit 140 underneath and around reflective elements 135. Reflective elements 135 have a variable phase state That is, the phase, i.e., time delay, of light reflected by reflective elements 135 can be varied. When the light is reflected by two or more of reflective elements 135, the light forms an interference pattern that influences the direction in which the light is reflected. As the phase state of an individual reflective element 135 is variable, it can be altered relative to the phase state of other reflective elements 135 to control the direction in which the light is reflected. A practical embodiment of array reflective elements 135 can be realized by employing a liquid crystal over an array of mirrors.

Circuit 140 controls the phase state, i.e., hologram, for reflective elements 135 to control the direction in which the light is reflected. Optionally, circuit 140 also computes the hologram. The result of the hologram is projected on fiber array 115, with points of intensity at one or more ports in fiber array 115. In FIG. 1 the light is shown as being directed from first port 120 to second port 125, however, in terms of functionality, first port 120 and second port 125 are preferably each a bi-directional input/output port.

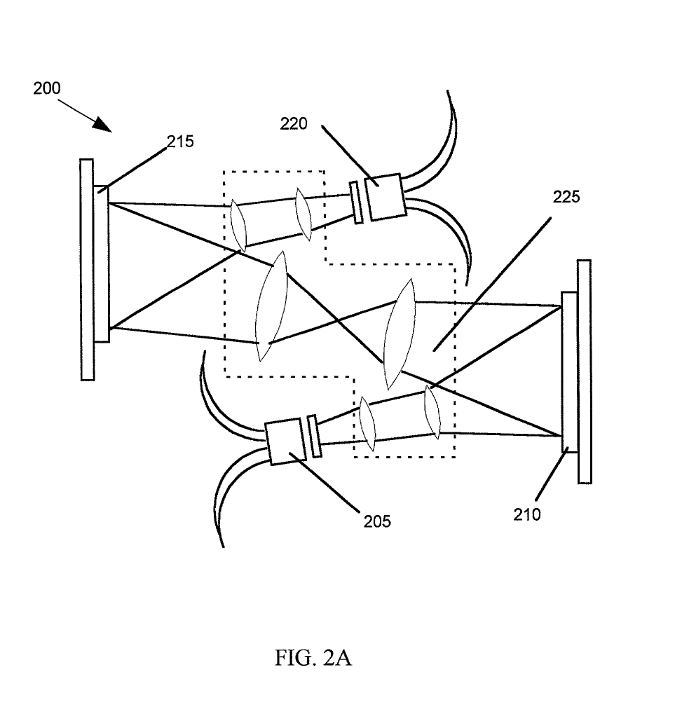

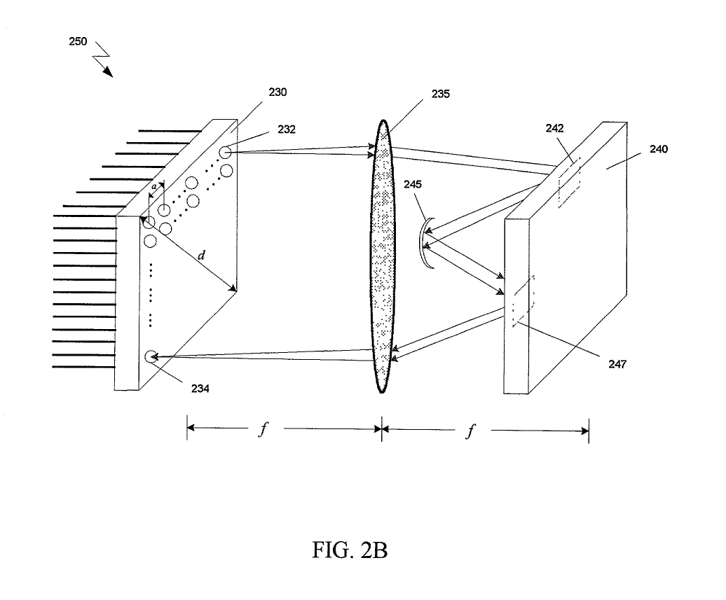

FIG. 2A is a schematic representation of an optical switch 200 configured with two SLMs 210 and 215, to provide a greater number of ports than that of the configuration in FIG. 1. Switch 200 also includes a first fiber array 205, a second fiber array 220, and a lens array 225.

First fiber array 205 and second fiber array 220 are each an array of bi-directional fiber ports. Lens array 225 is a series of refractive optical elements that transfer one or more optical beams through switch 200.

Input signals in the form of light beams or pulses are projected from one or more ports in first fiber array 205, through one or more lenses of lens array 225 onto SLM 210. SLM 210 produces a first routing hologram that directs the light through one or more lenses of lens array 225 onto SLM 215. SLM 215 produces a second routing hologram that directs the light through one or more lenses of lens array 225 onto one or more ports in second fiber array 220.

SLMs 210 and 215 each have an array of phase-variable reflective elements on its surface to produce reconfigurable phase holograms that control the deflection angle of a beam of light. Thus, light from any port of first fiber array 205 can be selectively routed to any port of second fiber array 220, and vice versa.

Switch 200 accommodates fiber arrays of a substantially greater dimension than that of typical prior art switches. For example, first fiber array 205 and second fiber array 220 may each have 1000 ports.

The optical configuration of switch 200 influences the distribution of the pixels on each of SLMs 210 and 215, and the manner in which a hologram is generated thereon. For example, the optical configuration influences the size of the region on each of SLMs 210 and 215 onto which the light is projected.

FIG. 2B is a schematic representation of an optical switch 250 in another embodiment of the present invention. Switch 250 includes an input/output fiber array 230, a lens 235, e.g., a Fourier transform lens, an SLM 240 and a reflector 245.

Light from a first port 232 of input/output fiber array 230 is projected through lens 235 onto a first region 242 of SLM 240. SLM 240 produces a first hologram in first region 242 that directs the light to reflector 245, which, in turn, directs the light to a second region 247 of SLM 240. SLM 240 produces a second hologram in second region 247 to direct the light through lens 235 and onto a selected second port 234 of input/output fiber array 230.

Referring again to FIG. 2A, the architecture in FIG. 2A can be made to mimic that of FIG. 2B by “folding” switch 200 about a central point. That is, the architecture of FIG. 2A approaches that of FIG. 2B by placing a mirror at the central point so that first fiber array 205 and second fiber array 220 are side by side, and SLM 210 and SLM 215 are side by side.

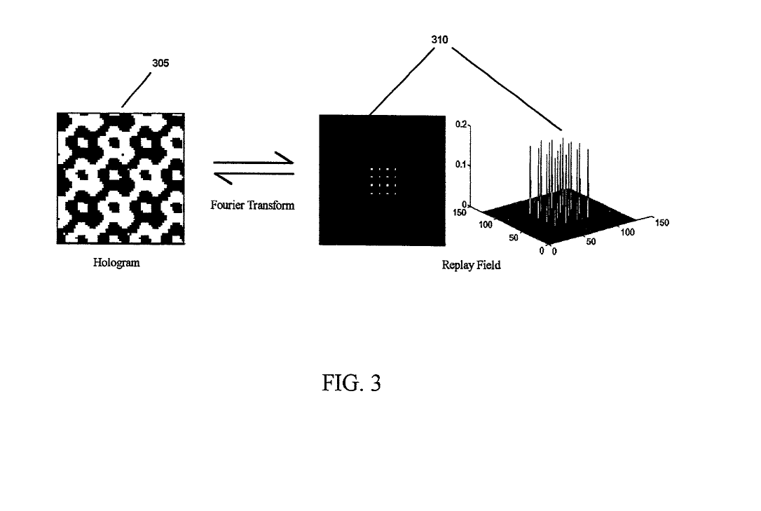

FIG. 3 is an illustration showing a relationship between a hologram and its replay field as can be provided by the optical switch of the present invention. Referring again to FIG. 2A for example, a reconfigurable phase hologram 305 is situated at a Fourier plane, e.g., on the array of phase-variable reflective elements at the surface of SLMs 210 and 215. In the preferred embodiment, phase hologram 305 is written into, that is, programmed into, the reflective elements to provide phase-only modulation of the incident light. The reflective elements diffract the light from first fiber array 205 to produce phase hologram 305. After a Fourier transform of the hologram, a resulting diffracted pattern, also known as a replay field 310, is produced at second fiber array 220.

Note that replay field 310 shows 16 points of light. FIG. 3 illustrates a feature of the present invention called multicasting. In a multicast, one input port is coupled to two or more output ports, i.e., simultaneous routing of light from one input port to a plurality of output ports. This can be done with a hologram that generates multiple peaks, as shown in replay field 310, rather than a single peak. FIG. 3 shows an example of a 1 to 16 multicast hologram. In a similar fashion, the same set of holograms can also be used to route multiple input ports to a single output port, referred to as multiplexing, provided that the inputs have different wavelengths. This can be used for wavelength division multiplexing (WDM).

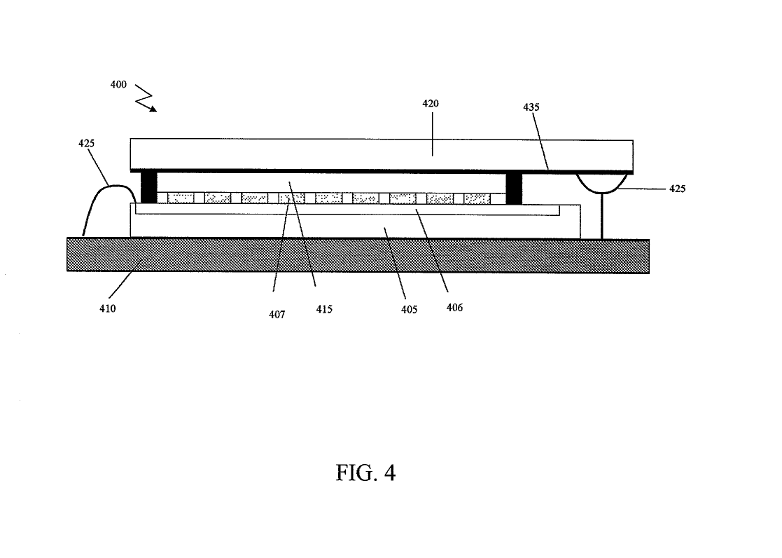

FIG. 4 shows a cross section of an exemplary SLM 400 in accordance with the present invention. The principal features of SLM 400 are a substrate 410 that carries (a) a silicon die 405 containing a circuit 406, (b) an array of mirrors 407, and (c) a liquid crystal element 415, which has a variable phase state. In FIG. 4, SLM 400 is configured to show liquid crystal element 415 positioned upon array of mirrors 407, which is positioned upon circuit 406. However, any convenient arrangement of these components is contemplated as being within the scope of the present invention.

The phase shift of light through liquid crystal element 415 is varied, or set for a specific value, by applying an electric field across liquid crystal element 415. Circuit 406 controls the phase state of liquid crystal element 415 by applying voltages to the array of mirrors 407 and thus developing the electric field across liquid crystal element 415. In practice each mirror 407 influences the phase state of a region of liquid crystal element 415 to which the mirror is adjacent. Thus, circuit 406 controls the phase state of a plurality of regions of liquid crystal element 415 by controlling the individual voltages applied to each of mirrors 407.

Circuit 406 executes the processes described herein, and it may include one or more subordinate circuits for executing portions of the processes or ancillary functions. In one embodiment of the present invention, circuit 406 includes a memory for storing data representative of a plurality of configurations of phase state for liquid crystal element 415, and a controller for utilizing the data and setting the phase states by applying signals to mirrors 407. Such data can be determined by an external system in a calibration procedure during manufacturing of SLM 400, or during manufacturing of an assembly in which SLM 400 is a component. The external system computes the phase states, and thereafter, the data is written into the memory of circuit 406. In another embodiment, circuit 406 includes a processor and associated memory for storing data in order to compute the phase states locally, and a controller to set the phases states by applying signals to mirrors 407.

SLM 400 also includes, on top of liquid crystal elements 415, a glass cover 420. Glass cover 420 has a layer 435 of Indium Tin Oxide (ITO) to provide a return path conductor for signals from circuit 406 via bond wires 425.

On the optical side of SLM 400, the array of mirrors 407 allows for steering of a light beam by producing a hologram using variable phase liquid crystal elements 415. In circuit 406, the following functionalities can be implemented:

DC balance schemes including shifting and scrolling;

Algorithms for reconfigurable beam steering and hologram generation;

Generation of multicast hologram patterns;

Hologram tuning for crosstalk optimization;

Hologram tuning for adaptive port alignment;

Phase aberration correction; and

Additional processing of various network traffic parameters.

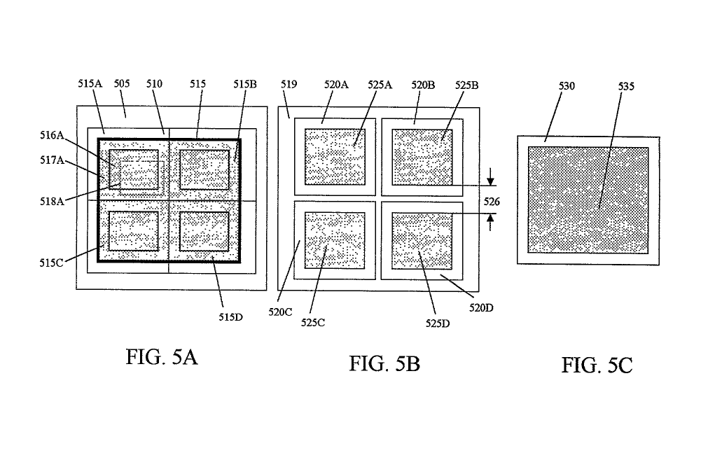

FIGS. 5A-5C illustrate several viable arrangements of phase-variable elements and circuitry on the SLM of the present invention. FIG. 5A illustrates a die-based arrangement with a substrate 505 carrying circuitry 510 around and/or underneath an array of phase-variable elements 515. The array of phase-variable elements 515 is partitioned into several subsets of phase-variable elements (515A, 515B, 515C and 515D), each operating as an independent SLM. FIG. 5B shows a substrate 519 carrying several groups of components, namely, circuitry 520A, 520B, 520C and 520D, and an array of phase-variable elements 525A, 525B, 525C and 525D, respectively. FIG. 5C shows an individual phase-variable element 535 and circuitry 530 for controlling phase-variable element 535.

In FIG. 5A, circuit 510 controls the operation of the full array of phase-variable elements, that is, each of 515A, 515B, 515C and 515D. FIG. 5A illustrates an arrangement in which four holograms can be simultaneously produced, i.e., one for each of subsets 515A, 515B, 515C and 515D. Circuit 510 computes a first phase state for subset 515A to direct a first light beam from a first port to a second port, and computes a second phase state for subset 515B to direct a second light beam from a third port to a fourth port. Similarly for subsets 515C and 515D, circuit computes respective phase states for routing of a third light beam and a fourth light beam. Because the phase states of the individuals in the array phase-variable elements 515 are individually reconfigurable, circuit 510 can determine which of phase-variable elements 515 are members of the first subset 515A, which of phase-variable elements 515 are members of the second subset 515B, and likewise, which of phase-variable elements 515 are members of the subsets 515C and 515D. In FIG. 5A, subsets 515A, 515B, 515C and 515D can be located adjacent to one another, or alternatively they can be spaced apart from one another by a region of substrate 505 that does not include any phase-variable elements.

An appropriate dimension for an array of phase-variable elements, i.e., pixels, per hologram, is about 100×100 pixels for good Gaussian beam performance. Accordingly, an array of 600×600 pixels provides for 36 holograms. However, the present invention is not limited to any particular dimension for the array, nor is it limited to any particular number of phase-variable elements or any arrangement of phase-variable elements. Theoretically, some beam steering functionality can be achieved with as few as two phase-altering elements, only one of which needs to have a variable phase. Furthermore, the phase-variable elements do not need to be arranged in an array, per se, as any suitable arrangement is contemplated as being within the scope of the present invention.

Referring again to FIG. 5B, a gap 526 is a region of substrate 519 that does not include any phase-variable elements. Gap 526 is located between phase-variable elements 525B and 525D, and thus prevents crosstalk between the holograms of phase-variable elements 525B and 525D.

The arrangement shown in FIG. 5A can deal with crosstalk in a manner different from that of FIG. 5B. In FIG. 5A, pixel subset 515A includes a region of pixels 516A upon which a hologram is produced. Pixel subset 515A also includes a subset of pixels 517A positioned along a peripheral edge of subset 516A. Subset 517A is thus a buffer region for preventing crosstalk between the hologram of subset 515A, and the holograms of subsets 515B and 515C.

Also, as those skilled in the art will appreciate, a hologram is shift invariant, that is the same replay field is generated for any shifted position of the hologram. Thus, as a further improvement, the phases of the pixels in subset 517A are set by circuit 510 to take advantage of the shift invariant property of the hologram such that a misalignment of the light beam incident on subset 515A will nevertheless produce the desired hologram. Therefore, provided that the misalignment is within a predetermined tolerance, i.e., such that the incident light falls within the bounds of subset 515A, the hologram is produced notwithstanding a misalignment of the light from an input port.

To take further advantage of the reconfigurable capability of the optical switch, circuit 510 receives a signal that represents whether light is being directed to a particular port. This feature enables circuit 510 to perform an adaptive optical alignment, where circuit 510 receives an input signal indicating that the light is to be directed from a first port to a second port. Circuit 510 locates the second port and then optimizes the hologram to minimize switch loss and crosstalk. For example, assume that pixel subset 515A is selected to direct light from the first port to the second port. Circuit 510 determines a position of the second port by successively recomputing the phase state for pixel subset 515A to successively redirect the light, and by successively evaluating the signal to determine whether the light is aligned with the second port.

A hologram can be calculated to route light to any position in the replay field. Hence, there are more positions to which the light can be routed in the replay field than there are pixels in the hologram. A hologram can be designed with a higher resolution replay field than the original hologram, creating a near continuous number of possible port positions at the output. This means that if a hologram, at first, directs light such that the light slightly misses a desired port, the hologram can be tuned or adjusted so that the desired port is hit and optimum coupling is achieved.

For example, circuit 510 computes a routing hologram for a port and then adjusts the hologram to minimize crosstalk. Thus, in a case where light is intended to be directed to a particular second port, circuit 510 computes the phase state for phase-variable elements 515 to minimize a level of stray light directed to ports other than the particular second port. Circuit 510 gradually changes the state of a few holograms and monitors a signal that indicates whether light is being received by ports other than the intended second port. Circuit 510 selects an appropriate hologram so that noise introduced by crosstalk into ports other than the intended second port is reduced.

The reconfigurable capability also permits for compensation for misalignment of the light beam projected onto an SLM from an input port. Circuit 510 determines a subset of phase-variable elements upon which the light from a first port is incident, and also determines a position of a desired second port to which the light is to be routed, and computes a suitable hologram to achieve that routing. That is, circuit 510 relocates the position of the hologram about a small area to aid in the alignment process. For example, in FIG. 5A, assume that in subset 515A a hologram is ideally produced by subset 516A, but the input beam is instead incident on subset 518A. Consequently, the level of light directed to the output port is lower than the optimum level. Accordingly, circuit 510 computes the phases of the pixels in subset 517A so that the hologram is produced by the elements of subset 518A, and thus the coupling of light from the input port to the output port is improved. In the computation, the circuit also considers parameters such as signal loss, crosstalk and wavelength. Circuit 510 also adaptively alters the hologram to control the deflection of a light signal to minimize fiber to fiber insertion loss.

An important consideration when operating a liquid crystal device is DC balancing. DC balancing ensures that the liquid crystal material is not subjected to a net DC electric field for more than some predetermined period of time, for example 1 or 2 minutes, before the field is reversed and DC balanced. For root-mean-square (RMS) responding liquid crystals such as nematics, DC balancing is inherent in an applied AC field, but for liquid crystals such as ferroelectrics, DC balancing is more difficult, as reversing the field reverses the orientation of the molecules.

A port to port connection may be continuously maintained for a long period of time. That is, minutes, days, months or, in a case of a protection or latency switch, years. Good design practice permits a maximum allowable disturbance to the power through the switch of 0.1 dB, hence frame inversion schemes cannot be used. On the other hand, because a hologram is shift invariant, the same replay field is generated for any shifted position of the hologram.

Circuit 510 employs a shifting and scrolling scheme using the invariance property of the hologram to perform DC balancing. Circuit 510 gradually shifts the hologram, changing the average state of the pixels, so that over several hundred frames, the net field is zero. Thus, circuit 510 balances the electric field across the liquid crystal elements to yield an average value of approximately zero volts. DC balancing must avoid changing too many pixels in the hologram at each frame update. Accordingly, the image is only partially shifted, in sections, to avoid a glitch of more then 0.1 dB per frame change.

Referring for example to FIG. 5A, each phase-variable element 515 has a series of interconnected paths defined within circuit 510 that dictates how the hologram pattern will be scrolled over multiple frames. In one embodiment the scrolling sequence depends on hardwire connections in circuit 510. In an alternative embodiment, a programmable scrolling system permits variable connections between the pixels such that each pixel can be changed to allow different scrolling schemes to be implemented to suit a particular application of the switch.

The present invention can employ any suitable hologram design algorithm, for example including, but not limited to:

(a) direct calculation from a blazed grating or Bragg diffractive angle,

(b) direct calculation from a quantized ideal phase profile,

(c) optimization by direct binary search,

(d) optimization by simulated annealing (Boltzmann annealing),

(e) optimization by a genetic algorithm, and

(f) optimization by constrained projection (Gerchberg-Saxton).

One technique for determining a hologram is by direct calculation from a quantized ideal phase profile. The ideal phase profile is obtained from the inverse Fourier transform of the replay field. The continuous phase profile is then quantized to the limited set of phase levels available.

A hologram can be calculated directly from the desired replay field via a Fourier transform, however the resulting hologram is a complex function of both amplitude and phase. The hologram h(x,y) is matched to the replay field H(u,v) via a Fourier transform such that:

H(u,v)=F_{T}[h(x,y)]

Once a hologram has been generated it can be evaluated by considering the loss to the routed port and the crosstalk to the unrouted ports, as well as the range of wavelengths that can be routed for less than a 0.1 dB loss variation. If the above-noted hologram is used, then the performance will be optimized in all respects. However, there is currently no technology capable of displaying this hologram in a real switch, and therefore it must be quantized. The hologram can be represented as having an amplitude and phase component.

H(u,v)=Hₐₘₚ(u,v)e^{1φ(u,v)}

An efficient hologram can be made by using just the phase information, as the amplitude does not contain much useful information for simple holographic replay fields. The present invention may use a phase only hologram:

H_{PO}(u,v)=e^{1φ(u,v)}

For a single port routing hologram, the information in the replay field, i.e., just one spot, is closely related to phase function, which means that the phase only quantization required for liquid crystal technology is very robust. The continuous structure of the phase. hologram, φ (u,v) means that it cannot easily be displayed in an optical system using current SLM technology. There are techniques that can be used to display either 4-level or 8-level phase only holograms, therefore the technique used to quantize the phase to those number of levels is very important.

The benefits of using multi-level phase are significant, especially in terms of loss and crosstalk. A binary phase hologram can only have a maximum efficiency of 41%, i.e., insertion loss of 4 dB, due to the symmetry that must be satisfied in the replay field. It is impossible to generate an asymmetric replay field with binary phase, hence half the light will always be wasted in the symmetry. If 4 levels of phase are used, then the attainable efficiency increases to 87% due to the breaking of the symmetry in the replay field, however, because of the structured noise generated by the 4-level quantization process, the crosstalk may not yet be ideal. 8-level phase modulation is preferred, as it allows a maximum efficiency of 93% and also generates much less structure in the noise, due to the lower degree of quantization required.

Another technique of displaying a hologram in a polarization insensitive manner is to use an FLC SLM to generate a binary phase hologram. A binary phase hologram can be generated by optimization, by direct calculation or by quantization of the phase only hologram. The technique of quantization most be chosen carefully to prevent sever distortion of the hologram replay field. The binary phase is selected from the phase only hologram by two thresholds a δ₁ and δ₂. The thresholding is done such that:

$${H}_{BPO} = \{ \begin{matrix}0 & {δ}_{1} \leq φ ( u , v ) \leq {δ}_{2} \\ π & otherwise\end{matrix}$$

The selection of the two boundaries is by exhaustive searching, as it depends on the shape and structure of the desired replay field. The benefits of this search process are not significant and it is only likely to improve the performance by a few percent. A safe threshold that provides consistent results is δ₁=−π/2, δ₂=π/2. More sophisticated thresholding techniques such as convolutional kernels and adaptive thresholds also give good results.

The hologram can be determined by direct calculation from the Bragg angle. A beam steering hologram for a single port can be modeled ideally as a Bragg grating of pitch d that generates a diffracted beam at an angle θ such that.

Sin θ=md/λ

where m is integer diffracted order and is usually set at m=1. The Blazed grating that is required to generate this angle is difficult to generate using a liquid crystal modulating technology due to its continuous phase profile. A quantized approximation of this blazed grating must be produced to generate a feasible routing hologram. This quantization algorithm can be incorporated into the circuit of the present invention.

A quantity of n pixels on the hologram can be combined to generate an approximation to a blazed grating. This process is fairly accurate and straightforward for a multi-level phase hologram, but is not so simple for a binary approximation. For a given n pixels per period, there are hundreds of combinations of pixels that will give similar routing performance to the desired port, but different noise fields and therefore different crosstalk values.

The present invention can compute a hologram using optimization by simulated annealing or direct binary search (DBS). There is no simple way of generating a hologram for other than simple cases such as gratings and checkerboards. In order to create a hologram that generates an arbitrary replay field, a more sophisticated algorithm is needed, especially if more advanced features such as crosstalk and multicasting are considered. To achieve this, the present invention uses optimization techniques such as simulated annealing or DBS.

The technique of DBS involves taking a hologram of random pixel values and calculating its replay field. The technique then flips the binary value of a randomly positioned pixel and calculates the new replay field. The technique then subtracts the two replay fields from the target replay field, sums the differences to form a cost function for the hologram before and after the pixel change. If the cost function after the pixel has been flipped is less than the cost function before the pixel was flipped, then the pixel change is considered to be advantageous and it is accepted. The new cost function is then used in comparison to another randomly chosen flipped pixel. This process is repeated until no further pixels can be flipped to give an improvement in the cost function.

The procedure for direct binary search is summarized as follows:

(1) Define an ideal target replay field, T (desired pattern).

(2) Start with a random array of binary phase pixels.

(3) Calculate its replay field (FT), H₀.

(4) Take the difference between T and H₀ and then sum up to make the first cost, C₀.

(5) Flip a pixel state in a random position.

(6) Calculate the new replay field, H₁.

(7) Take the difference between T and H₁, then sum up to make the second cost, C₁.

(8) If C₀<C₁ then reject the pixel flip and flip it back.

(9) If C₀>C₁ then accept the pixel flip and update the cost C₀ with the new cost C₁.

(10) Repeat steps 5 through 9 until |C₀−C₁| reaches a minimum value.

More sophisticated techniques are required to fully exploit the possible combinations of pixel values in the hologram. One such algorithm is simulated annealing, which uses DBS, but also includes a probabilistic evaluation of the cost function that changes as the number of iterations increases. The idea is to allow the hologram to ‘float’ during the initial iteration, with good and bad pixel flips being accepted. This allows the optimization to float into a more global minima rather than resulting in a local minima as is the case with DBS.

An alternative technique for optimizing a hologram is to use the Genetic Algorithm (GA), which will converge to multiple solutions much quicker than DBS and simulated annealing. The GA is based on real evolution in biological systems, often referred to ‘survival of the fittest’. The concept behind the GA is to use a controlled mutation to evolve a generation of solutions and then select the best to be further mutated towards an optimal family of solutions. The GA can be implemented at the pixel level in the present invention. It also advantageously generates a whole family of optimal solutions, which could provide diversity in crosstalk and wavelength performance.

In the GA, members of a next generation are selected based on a probability proportional to their fitness. The expectation is that this process will eventually converge to yield a population dominated with the global maximum of fitness function. The algorithm typically starts with a pool of randomly generated arrays. It then evaluates the cost function, which is based on the mean square error, associated with each of these and discards those with worst cost value. It then randomly takes two of the arrays out of the remaining pool and uses them as parents. An offspring is created by randomly mixing the values from each parent. This offspring is then randomly altered, i.e., mutated, and a new cost function is evaluated. The above steps are repeated until no further improvement in the cost function can be detected. The aim of the design is to produce a desired target function g′ at the output plane. The cost function, which is a measure of the fitness of the final result, can be defined as:

C={|g|²−|g′|²}²

where g is the calculated output and g′ is the desired target function or replay field. The aim of optimization is to minimize the cost function and obtain a solution as close as possible to the desired target.

Different schemes can be used for the mutation and crossover. For instance, a straight method of breeding would entail splitting the parents at random points and then splicing them to obtain the offspring. However, alternative methods can be used in order to utilize the whole area of parents. Alternative approaches can also be applied to the mutation process, such as random pixel changes each cycle, e.g., for a binary case this would be changing a 1 to −1. Alternatively they can be done based on a probability where the mutation probability can be set to:

p=pₒ(1/IT)^{r}

Where r and pₒ are parameters that depend on algorithm, and IT is the number of iterations. The number of bits to be mutated is determined by mutation probability multiplied by size of the object function:

Nₘᵤₜₐₜᵢₒₙ=p×N

In practice the bit to be mutated is also chosen randomly. The process is summarized as follows:

(1) Start—select a random population of M member functions and evaluate their cost;

(2) Reproduce—select L (L<M) samples with lower values of cost function, and discard the rest;

(3) Crossover—make crossover between the L seeds to produce M−1 offspring;

(4) Mutation—mutate the offspring by randomly changing the phase of elements;

(5) Evaluation—evaluate the cost function for the new offspring; and

(6) Iteration—iterate steps (2) through (5) until the value of the cost function can not be reduced.

More sophisticated algorithms such as projection of constrained sets, also known as the Gerchberg-Saxton algorithm, can also be used to generate holograms. This algorithm operates on an entire hologram array, however it is a fairly complex mathematical process and involves the use of the fast Fourier transform (FFT). Assuming an optical system with an illumination profile of Iₐ,(x,y)=a²(x,y), and also assuming a desire to generate a phase only hologram ψ(x,y), then in the replay field of the hologram there is a desired intensity distribution I_{b}(u,v)=b²(u,v) with an associated phase of Φ(u,v), which is usually left as a free parameter in the iterative process. The process begins with the specification of the desired distribution b(u,v) and an estimate of Φ(u,v).

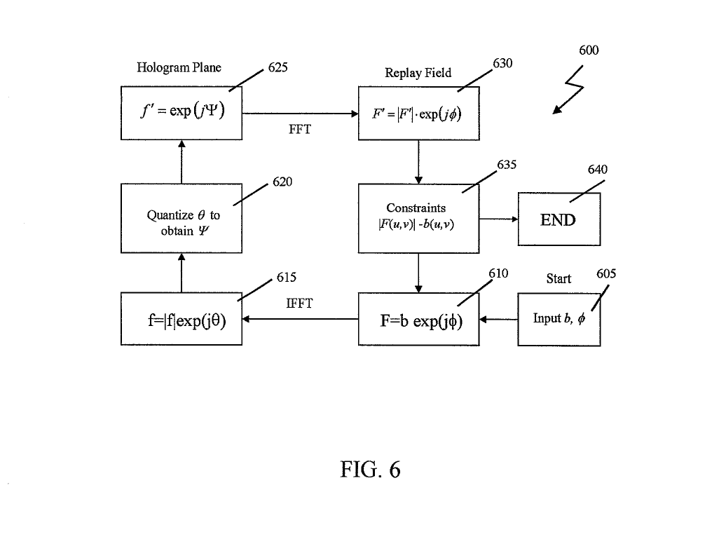

FIG. 6 is a flowchart of an algorithm for generating a hologram by projection of constrained sets. The algorithm begins with step 605.

In step 605, the algorithm sets the desired output replay field magnitude, b, as well as an initial replay field phase profile, Φ which may be generated randomly. Thereafter, the algorithm progresses to step 610.

In step 610, the algorithm computes a value for the complex replay field, F, from b and Φ. Thereafter, the algorithm progresses to step 615.

In step 615, the algorithm computes the fast inverse fourier transform (IFFT) of the complex output optical field to obtain a value for the hologram plane complex optical field, f. Thereafter, the algorithm progresses to step 620.

In step 620, the algorithm extracts the phase profile from the hologram plane complex optical field and based on the quantization levels available in the hologram, calculates a quantized phase profile Ψ. Thereafter, the algorithm progresses to step 625.

In step 625, the algorithm computes a new value for the hologram plane complex optical field, f, based on the quantized phase profile. Thereafter, the algorithm progresses to step 630.

In step 630, the algorithm computes the fast fourier transform (FFT) of the hologram plane complex optical field to obtain a new value for complex optical relay field, F′. Thereafter, the algorithm progresses to step 635.

In step 635, the algorithm extracts the magnitude of the replay field and compares it with the desired target b. If the difference between the replay field magnitude and the desired target is less than a pre-determined value, then the algorithm progresses to step 640, otherwise the algorithm extracts a new value for the phase profile Φ, and loops back to step 610, for another round of optimization.

In step 640, the algorithm terminates.

The iterative process of FIG. 6 is defined by the two constraints in the system. The replay field constraint is to generate the desired intensity distribution I_{b}(u,v) and the constraints in the hologram plane are both the input illumination Iₐ(x,y) and the restrictions on the phase only hologram ψ(x,y) due to the required phase quantization, e.g., binary, 4-level phase, or 8-level phase.

In a practical optical implementation of an optical switch, there are several tradeoffs that must be made between switch performance, optical componentry and opto-mechanics. An example of this is the phase term generated when an object is not placed in the focal plane of a Fourier transform lens. If an object, such as a hologram, s(xy) is placed a distance d from the focal plane of a positive lens with a focal length f, then a spherical phase error term is added to the Fourier transform of the object:

$$S ( u , v ) = \frac{{ⅇ}^{j f λ ( 1 - \frac{d}{f} ) ( {u}^{2} + {v}^{2} )}}{j λ f} {F}_{T} [ s ( x , y ) ]$$

The spherical phase term denoted by the exponential term in the fraction of this equation can lead to aberrations in the rest of the optical components as well as poor launch efficiency into the fiber at the output. However, this phase error can be calculated or determined by optical simulation with either direct analysis or by using a ray tracing software package. Once the error is known, it can be incorporated into the hologram design algorithm and the hologram can be made to compensate, and therefore correct, for the phase error. This phase error correction can also be implemented within the circuit of the present invention. By including the phase error among the parameters processed by the circuit, the phase error can be evaluated as part of the hologram calculation algorithm. Accordingly, circuit 510 receives a signal that represents a phase error of light at an output port, and in response to the signal, computes the phase state for the phase-variable elements 515 to correct for the phase error.

The optical switch of the present invention can also arbitrate between selected output ports. Referring again to FIG. 5A, each of pixel array subsets 515A, 515B, 515C and 515D can be controlled to generate a routing hologram for any specified output port or, in the case of a multicast, any set of a plurality of output ports. Accordingly, circuit 510 contains the routing information for all possible routing configurations.

Circuit 510 receives an input signal, i.e. a port allocation signal, indicating that light is to be directed from a particular first port to a particular second port. Such a port allocation signal will originate from a source external to the optical switch. The external source may not necessarily be aware of all the port allocation assignments that have been sent to the optical switch. If circuit 510 receives a port allocation signal specifying a particular output port, and if that output port is already dedicated to a different routing configuration, then a clash will occur unless arbitration is employed. In the case of a clash, circuit 510 can take two possible courses of action.

(i) If there is a clash between output ports, then circuit 510 will provide a flag or other output signal indicating that a port contention has occurred. An upper layer of a network control structure can use this output signal.

(ii) If a clash occurs, then circuit 510 re-routes the light to an alternative unused output port, i.e., a third port. Circuit 510 will also issue an output signal indicating that the re-routing has occurred. An upper layer of a network control structure can use this output signal.

It should be understood that various alternatives and modifications can be devised by those skilled in the art. The present invention is intended to embrace all such alternatives, modifications and variances that fall within the scope of the appended claims.

What is claimed is:

1. An electro-optical component comprising:
a substrate;
a phase-variable element carried on said substrate;
a memory carried on said substrate for storing data representative of a phase state for said phase-variable element; and
a controller carried on said substrate, for utilizing said data and setting said phase state for said phase-variable element.

2. An electro-optical component comprising:
a substrate;
a phase-variable element carried on said substrate; and
a circuit carried on said substrate for computing a phase state for said phase-variable element.

3. An optical switch comprising:
a substrate;
a phase-variable element carried on said substrate;
a memory carried on said substrate for storing data representative of a phase state for said phase-variable element; and
a controller carried on said substrate for utilizing said data and setting said phase state for said phase-variable element to direct a light from a first port to a second port.

4. An optical switch comprising:
a substrate;
a phase-variable element carried on said substrate; and
a circuit carried on said substrate for computing a phase state for said phase-variable element to direct a light from a first port to a second port.

5. The optical switch of claim 4, wherein said circuit sets said phase state for said phase-variable element to direct a light from a first port to a second port.

6. The optical switch of claim 4, wherein said phase-variable element comprises a region of a liquid crystal.

7. The optical switch of claim 4, further comprising a mirror carried on said substrate for reflecting said light through said phase-variable element.

8. The optical switch of claim 4,
wherein said phase-variable element is one of a plurality of phase-variable elements carried on said substrate, and
wherein said circuit computes a phase state for said plurality of phase-variable elements to direct said light from said first port to said second port.

9. The optical switch of claim 8, wherein said circuit sets said phase state for said plurality of phase-variable elements.

10. The optical switch of claim 8, wherein said plurality of phase-variable elements comprises a plurality of regions of a liquid crystal.

11. The optical switch of claim 10, wherein said circuit balances an electric field across said plurality of regions of said liquid crystal to yield an average value of approximately zero volts.

12. The optical switch of claim 8, wherein said second port is one of a plurality of ports to which said plurality of phase-variable elements can direct said light.

13. The optical switch of claim 12, wherein said circuit computes said phase state for said plurality of phase-variable elements to minimize a level of stray light directed to said plurality of ports other than said second port.

14. The optical switch of claim 12, wherein said circuit computes said phase state for said plurality of phase-variable elements to simultaneously direct said light to another of said plurality of ports.

15. The optical switch of claim 8, wherein said plurality of phase-variable elements is configured in an array.

16. The optical switch of claim 8, wherein said plurality of phase-variable elements directs said light by diffracting said light.

17. The optical switch of claim 8, wherein said plurality of phase-variable elements directs said light by phase modulating said light.

18. The optical switch of claim 17, wherein said phase modulating produces a one-dimensional or two-dimensional image on said plurality of phase-variable elements.

19. The optical switch of claim 8, wherein said phase state for said plurality of phase-variable elements is a hologram displayed on said plurality of phase-variable elements.

20. The optical switch of claim 19, wherein said hologram is computed from an algorithm selected from the group consisting of:
(a) direct calculation from a blazed grating or Bragg diffractive angle,
(b) direct calculation from a quantized ideal phase profile,
(c) optimization by direct binary search,
(d) optimization by simulated annealing (Boltzmann annealing),
(e) optimization by a genetic algorithm, and
(f) optimization by constrained projection (Gerchberg-Saxton).

21. The optical switch of claim 8,
wherein said circuit receives a signal that represents whether said light is being directed to said second port, and
wherein said circuit computes said phase state for said plurality of phase-variable elements to align said light with said second port, in response to said signal.

22. The optical switch of claim 21, wherein said circuit determines a position of said second port by successively recomputing said phase state for said plurality of phase-variable elements to successively redirect said light, and by successively evaluating said signal to determine whether said light is aligned with said second port.

23. The optical switch of claim 8,
wherein said circuit receives a signal that represents a phase error of said light at said second port, and
wherein said circuit computes said phase state for said plurality of phase-variable elements to correct for said phase error, in response to said signal.

24. The optical switch of claim 8, wherein said first port is one of a plurality of ports from which said plurality of phase-variable elements can direct light to said second port.

25. The optical switch of claim 24, wherein said circuit computes said phase state for said plurality of phase-variable elements to direct light from another of said plurality of ports to said second port.

26. The optical switch of claim 8, wherein said first port and said second port are each a bi-directional input/output port.

27. The optical switch of claim 8,
wherein said first port and said second port are two of a plurality of ports between which said light can be directed by said plurality of phase-variable elements, and
wherein said circuit receives an input signal indicating that said light is to be directed from said first port to said second port.

28. The optical switch of claim 27, wherein said circuit issues an output signal indicating a port contention, if said second port is in use when said circuit receives said input signal.

29. The optical switch of claim 27, wherein said circuit computes said phase state for said plurality of phase-variable elements to direct said light from said first port to a third port, if said second port is in use when said circuit receives said input signal.

30. The optical switch of claim 29, wherein said circuit issues an output signal indicating that said light is being directed to said third port, if said second port is in use when said circuit receives said input signal.

31. The optical switch of claim 8,
wherein said phase state for said plurality of phase-variable elements is a hologram displayed on said plurality of phase-variable elements,
wherein said plurality of phase-variable elements are in an arrangement such that said hologram is produced notwithstanding a misalignment of said light from said first port, and
wherein said misalignment is within a predetermined tolerance.

32. The optical switch of claim 31, wherein said plurality of phase-variable elements includes a subset of said plurality of phase-variable elements positioned along a peripheral edge of said arrangement to utilize a shift invariant property of said hologram.

33. The optical switch of claim 8,
wherein said phase state for said plurality of phase-variable elements is a first phase state for a first subset of said plurality of phase-variable elements, and
wherein said circuit computes a second phase state for a second subset of said plurality of phase-variable elements for directing light from a third port to a fourth port.

34. The optical switch of claim 33, wherein said circuit determines (a) which of said plurality of phase-variable elements are members of said first subset and (b) which of said plurality of phase-variable elements are members of said second set.

35. The optical switch of claim 33, wherein said first subset is immediately adjacent to said second subset.

36. The optical switch of claim 33, wherein said first subset is spaced apart from said second subset by a region of said substrate that does not include any of said plurality of phase-variable elements.

37. The optical switch of claim 8,
wherein said phase state for said plurality of phase-variable elements is a first phase state for a first subset of said plurality of phase-variable elements, and
wherein said optical switch further comprises a second circuit for computing a second phase state for a second subset of said plurality of phase-variable elements for directing light from a third port to a fourth port.

38. The optical switch of claim 37, wherein said first subset is spaced apart from said second subset by a region of said substrate that does not include any of said plurality of phase-variable elements.

39. The optical switch of claim 8, wherein said circuit determines a subset of said plurality of phase-variable elements upon which said light from said first port is incident.

40. The optical switch of claim 8, further comprising a lens for collimating said light interposed between said first port and said plurality of phase-variable elements.

41. The optical switch of claim 8, further comprising a lens for focusing said light interposed between said plurality of phase-variable elements and said second port.

42. An optical switch comprising:
a substrate;
a liquid crystal carried on said substrate; and
a circuit carried on said substrate for (a) computing a hologram and (b) controlling said liquid crystal to produce said hologram to direct a light from a first port to a second port.
